(19) United States
(12) Patent Application Publication
(10) Pub. No.: US 2014/0104537 A1
(43) Pub. Date: Apr. 17, 2014

(54) SLIM BEZEL LIQUID CRYSTAL DISPLAY DEVICE

(71) Applicants: Gang Yu, Shenzhen (CN); Liuyang Yang, Shenzhen (CN)

(72) Inventors: Gang Yu, Shenzhen (CN); Liuyang Yang, Shenzhen (CN)

(73) Assignee: Shenzhen China Star Optoelectronics Technology Co., Ltd., Shenzhen, Guangdong (CN)

(21) Appl. No.: 13/805,656

(22) PCT Filed: Oct. 26, 2012
(86) PCT No.: PCT/CN2012/083529

§ 371 Date: Dec. 19, 2012

(30) Foreign Application Priority Data
Oct. 12, 2012 (CN) 201210387468.1

(51) Int. Cl. G02F 1/1333

(52) U.S. Cl. CPC G02F 1/133308
USPC 349/58

(57) ABSTRACT

The present invention provides a slim bezel liquid crystal display device, which includes a rear enclosure, a front enclosure mating the rear enclosure, and a liquid crystal display module arranged inside the rear enclosure. The liquid crystal display module has opposite sides each forming a first retention section. The rear enclosure forms second retention sections corresponding to the first retention sections. The first retention sections and the second retention sections are engageable with and coupled to each other so as to fix the liquid crystal display module inside the rear enclosure. The slim bezel liquid crystal display device includes the first retention sections formed on the liquid crystal display module and the second retention sections formed on the rear enclosure and the first and second retention sections are engageable with and coupled to each other to fix the liquid crystal display module in the rear enclosure.

### BACKGROUND OF THE INVENTION

1. Field of the Invention

The present invention relates to the field of liquid crystal displaying, and in particular to a slim bezel liquid crystal display device.

2. The Related Arts

Liquid crystal display (LCD) has numerous advantages, such as thin device body, less power consumption, and being free of radiation, and is thus widely used. Most of the liquid crystal display devices that are available in the market are backlighting liquid crystal displays, which comprise a liquid crystal display panel and a backlight module. The operation principle of the liquid crystal display panel is that liquid crystal molecules are arranged between two parallel glass substrates and electricity is selectively applied to the glass substrates to cause change of the orientation of the liquid crystal molecules in order to refract out the light from a backlight module for formation of an image.

A conventional liquid crystal display device generally comprises a rear enclosure, a front enclosure that mates the rear enclosure and a liquid crystal display module arranged in the rear enclosure. The liquid crystal display module is often fixed inside the rear enclosure by being screwed from the front side to the rear side. And then, the front enclosure is fit to the rear enclosure. Referring to FIG. 1, a schematic view is given to show an assembling structure of a conventional liquid crystal display module, which comprises an outer frame 100 forming bolt mounting zones 300. The bolt mounting zones 300 form bolt holes 500 and bolts are received through the bolt holes 500 to fix the liquid crystal display module in the rear enclosure. Due to the arrangement of the bolt mounting zones 300, the front enclosure needs a wide bezel to cover the bolt mounting zones 300. Consequently, a non-display zone of the liquid crystal display device is thus expanded. Further, since the manner of fixing is done by screwing from the front side to the rear side, the thickness of the liquid crystal display device is thus increased. With the constant progress of the manufacturing techniques of liquid crystal display device, the trend of development of liquid crystal display device is now toward bezel slimming and device thinning. The manner of fixing the liquid crystal display module to the rear enclosure affects the bezel width and overall thickness of the liquid crystal display device to quite an extent.

### SUMMARY OF THE INVENTION

An object of the present invention is to provide a slim bezel liquid crystal display device, which has a simple structure, is easy to maintain, can effectively realize bezel slimming and device thinning of the liquid crystal display device, and is capable of effectively controlling maintenance cost.

To achieve the object, the present invention provides a slim bezel liquid crystal display device, which comprises a rear enclosure, a front enclosure mating the rear enclosure, and a liquid crystal display module arranged inside the rear enclosure. The liquid crystal display module has opposite sides each forming a first retention section. The rear enclosure forms second retention sections corresponding to the first retention sections. The first retention sections and the second retention sections are engageable with and coupled to each other so as to fix the liquid crystal display module inside the rear enclosure.

The liquid crystal display module comprises a back frame and a liquid crystal display panel received in the back frame. The first retention sections are respectively formed on opposite sides of the back frame.

The rear enclosure comprises a bottom board, first and second side boards respectively connected to opposite sides of the bottom board, and a third side board connected to the bottom board and also connected to the first and second side boards. The bottom board and the first, second, and third side boards delimit an accommodation space that has an opening. The liquid crystal display module is received in the accommodation space.

The second retention sections are formed in inside surfaces of the first and second side boards to respectively correspond to the first retention sections.

The front enclosure comprises a frame body and a stop plate extending from one side of the frame body. The stop plate is provided to correspond to the opening of the rear enclosure, whereby after assembling, the stop plate completely covers and shields the opening.

The first retention sections are raised portions. The first retention sections project outwardly from the opposite sides of the back frame. The second retention sections are slots. The second retention sections are formed by recessing inside surfaces of the first and second side boards.

The first retention sections have a rectangular cross-section. The second retention sections are rectangular slots corresponding to the first retention sections.

The first retention sections have a trapezoidal cross-section. The first retention sections get expanded in extending outward from the end thereof adjacent to the back frame. The second retention sections are trapezoidal slots corresponding to the first retention sections.

The first retention sections are slots. The first retention sections are formed by inwardly recessing opposite sides of the back frame. The second retention sections are raised portions. The second retention sections are formed by projecting inwardly from inside surfaces of the first and second side boards.

The first retention sections are rectangular or trapezoidal slots and the second retention sections have a cross-section that is trapezoidal or rectangular in shape to correspond to the first retention sections.

The present invention also provides a slim bezel liquid crystal display device, which comprises a rear enclosure, a front enclosure mating the rear enclosure, and a liquid crystal display module arranged inside the rear enclosure, the liquid crystal display module having opposite sides each forming a first retention section, the rear enclosure forming second retention sections corresponding to the first retention sections, the first retention sections and the second retention sections being engageable with and coupled to each other so as to fix the liquid crystal display module inside the rear enclosure;

wherein the liquid crystal display module comprises a back frame and a liquid crystal display panel received in the back frame, the first retention sections being respectively formed on opposite sides of the back frame;

wherein the rear enclosure comprises a bottom board, first and second side boards respectively connected to opposite sides of the bottom board, and a third side board connected to the bottom board and also connected to the first and second side boards, the bottom board and the first, second, and third side boards delimiting an accommodation space that has an opening, the liquid crystal display module being received in the accommodation space;

wherein the second retention sections are formed in inside surfaces of the first and second side boards to respectively correspond to the first retention sections;

wherein the front enclosure comprises a frame body and a stop plate extending from one side of the frame body, the stop plate being provided to correspond to the opening of the rear enclosure, whereby after assembling, the stop plate completely covers and shields the opening;

wherein the first retention sections are raised portions, the first retention sections projecting outwardly from the opposite sides of the back frame, the second retention sections being slots, the second retention sections being formed by recessing inside surfaces of the first and second side boards; and

wherein the first retention sections have a rectangular cross-section, the second retention sections being rectangular slots corresponding to the first retention sections.

The efficacy of the present invention is that the present invention provides a slim bezel liquid crystal display device, which comprises first retention sections formed on the liquid crystal display module and second retention sections formed on the rear enclosure, whereby the first and second retention sections are engageable with and coupled to each other to fix the liquid crystal display module in the rear enclosure. The structure is simple and the operation is easy so as to effectively achieve bezel slimming and device thinning of a liquid crystal display device. Further, easy disassembling can be done with the liquid crystal display module in case of maintenance and replacement so that the maintenance cost can be effectively controlled.

For better understanding of the features and technical contents of the present invention, reference will be made to the following detailed description of the present invention and the attached drawings. However, the drawings are provided for the purposes of reference and illustration and are not intended to impose undue limitations to the present invention.

### BRIEF DESCRIPTION OF THE DRAWINGS

The technical solution, as well as beneficial advantages, of the present invention will be apparent from the following detailed description of an embodiment of the present invention, with reference to the attached drawings. In the drawings:

FIG. 1 is a schematic view showing an assembling structure of a conventional liquid crystal display module;

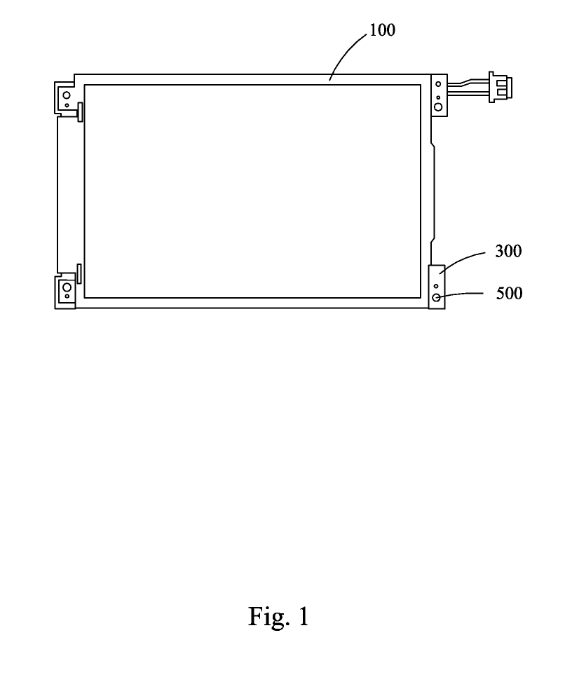

FIG. 2 is an exploded view showing a slim bezel liquid crystal display device according to a first embodiment of the present invention;

FIG. 3 is an exploded view showing a slim bezel liquid crystal display device according to a second embodiment of the present invention;

FIG. 4 is an exploded view showing a slim bezel liquid crystal display device according to a third embodiment of the present invention; and

FIG. 5 is an exploded view showing a slim bezel liquid crystal display device according to a fourth embodiment of the present invention.

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

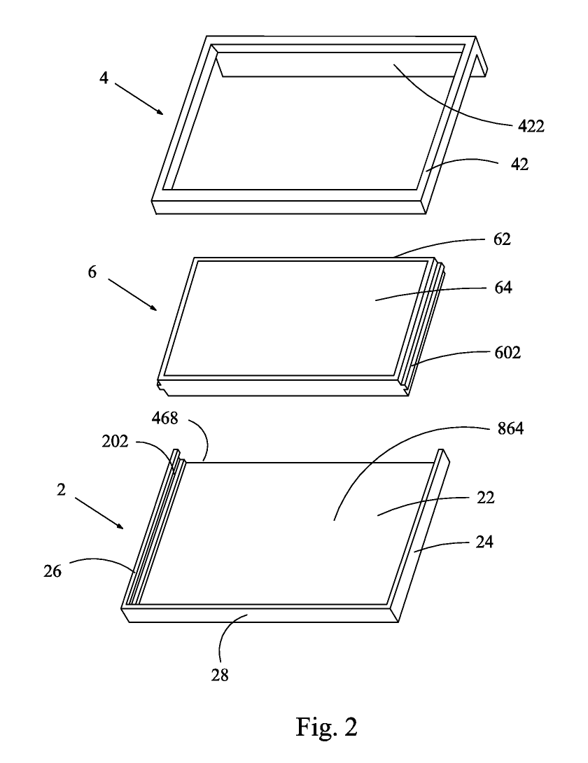

Referring to FIG. 2, the present invention provides a slim bezel liquid crystal display device, which comprises a rear enclosure 2, a front enclosure 4 mating the rear enclosure 2, and a liquid crystal display module 6 arranged inside the rear enclosure 2. The liquid crystal display module 6 has opposite sides each forming a first retention section 602. The rear enclosure 2 forms second retention sections 202 corresponding to the first retention sections 602. The first retention sections 602 and the second retention sections 202 are engageable with and coupled to each other so as to fix the liquid crystal display module 6 inside the rear enclosure 2. The coupling between the liquid crystal display module 6 and the rear enclosure 2 can thus be effected with a simple structure and easy operation, whereby bezel slimming and device thinning of the liquid crystal display device can be realized. Further, easy disassembling can be done with the liquid crystal display module in case of maintenance and replacement so that the maintenance cost can be effectively controlled.

The liquid crystal display module 6 comprises a back frame 62 and a liquid crystal display panel 64 received in the back frame 62. The first retention sections 602 are respectively formed on opposite sides of the back frame 62. In the instant embodiment, the first retention sections 602 are raised portions and the first retention sections 602 are formed by respectively projecting outward from the opposite sides of the back frame 62.

The rear enclosure 2 comprises a bottom board 22, first and second side boards 24, 26 respectively connected to opposite sides of the bottom board 22, and a third side board 28 connected to the bottom board 22 and also connected to the first and second side boards 24, 26. The bottom board 22 and the first, second, and third side boards 24, 26, 28 delimit an accommodation space 864 that has an opening 468. The liquid crystal display module 6 is received in the accommodation space 864.

The second retention sections 202 are formed in inside surfaces of the first and second side boards 24, 26 to respectively correspond to the first retention sections 602. In the instant embodiment, the second retention sections 202 are slotted portions and the second retention sections 202 are formed by recessing the inside surfaces of the first and second side boards 24, 26.

Preferably, the first retention sections 602 have a cross-sectional shape that is rectangular. The second retention sections 202 are thus rectangular slots corresponding to the first retention sections 602.

The front enclosure 4 comprises a frame body 42 and a stop plate 422 extending from one side of the frame body. The stop plate 422 is provided to correspond to the opening 468 of the rear enclosure 2. After assembling, the stop plate 422 may completely cover and shield the opening 468 so as to retain the liquid crystal display module 6 between the front enclosure 4 and the rear enclosure 2.

To assemble, the liquid crystal display module 6 is inserted through the opening 468 of the rear enclosure 2 into the accommodation space 864 with the first and second retention sections 602, 202 engaging each other. Then, the front enclosure 4 is set to mate the rear enclosure 2 with the stop plate 422 of the front enclosure 4 completely shielding the opening 864 so as to retain the liquid crystal display module 6 between the front enclosure 4 and the rear enclosure 2.

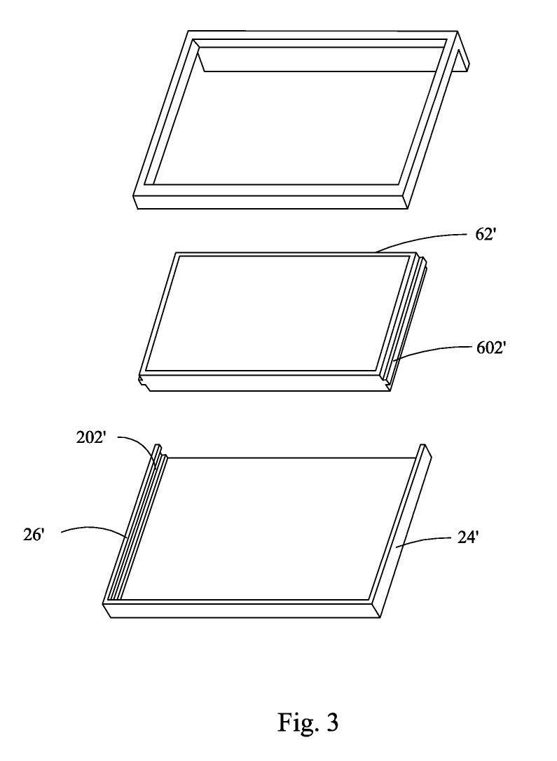

Referring to FIG. 3, an exploded view is given to show a slim bezel liquid crystal display device according to a second embodiment of the present invention. In the instant embodiment, the first retention sections 602′ are raised portions having a trapezoidal cross-section. The first retention sections 602′ are expanded in extending outward from the end thereof adjacent to the back frame 62′. The second retention sections 202′ are slots that are trapezoidal slots to correspond to the first retention sections 602′. The second retention sections 202′ are formed by recessing the inside surfaces of the first and second side boards 24′, 26′. A similar technique effect to that of the above embodiment can be achieved.

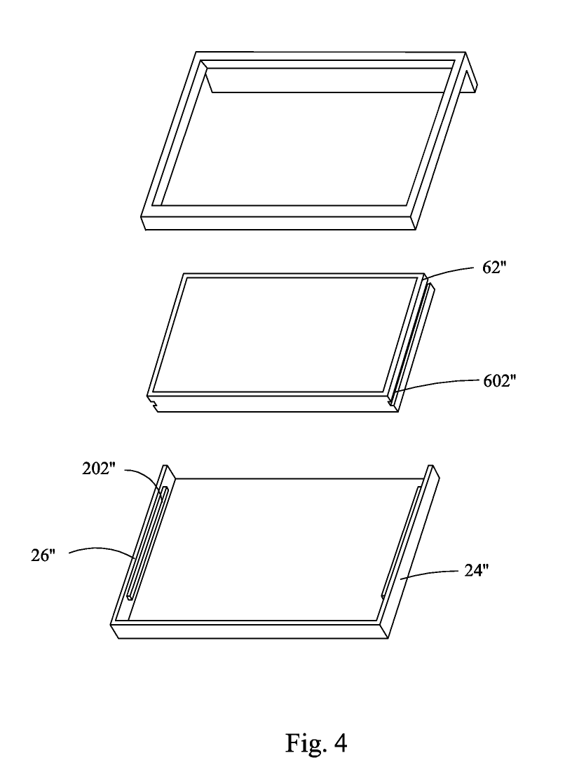

Referring to FIG. 4, an exploded view is given to show a slim bezel liquid crystal display device according to a third embodiment of the present invention. In the instant embodiment, the first retention sections 602″ are slots and the first retention sections 602″ are formed by inwardly recessing the opposite sides of the back frame 62″. The first retention sections 602″ are rectangular slots. The second retention sections 202″ are raised portions. The second retention sections 202″ are formed by projecting inwardly from inside surfaces of the first and second side boards 24″, 26″. The second retention sections 202″ are arranged to correspond to the first retention sections 602″. The second retention sections 202″ have a rectangular cross-section. A similar technique effect to that of the above embodiments can be achieved.

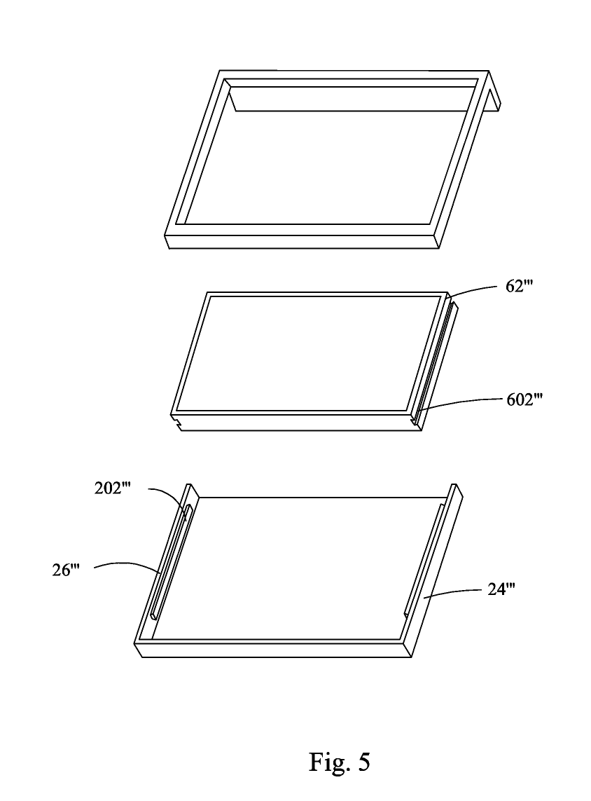

Referring to FIG. 5, an exploded view is given to show a slim bezel liquid crystal display device according to a fourth embodiment of the present invention. In the instant embodiment, the first retention sections 602′″ are slots and the first retention sections 602′″ are formed by inwardly recessing the opposite sides of the back frame 62′″. The first retention sections 602′″ are trapezoidal slots. The second retention sections 202′″ are raised portions and the second retention sections 202′″ are formed by projecting outwardly from inside surfaces of the first and second side boards 24′″, 26′″. The second retention sections 202′″ are arranged to correspond to the first retention sections 602′″. The second retention sections 202′″ have a trapezoidal cross-section. A similar technique effect to that of the above embodiments can be achieved.

In summary, the present invention provides a slim bezel liquid crystal display device, which comprises first retention sections formed on the liquid crystal display module and second retention sections formed on the rear enclosure, whereby the first and second retention sections are engageable with and coupled to each other to fix the liquid crystal display module in the rear enclosure. The structure is simple and the operation is easy so as to effectively achieve bezel slimming and device thinning of a liquid crystal display device. Further, easy disassembling can be done with the liquid crystal display module in case of maintenance and replacement so that the maintenance cost can be effectively controlled.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A slim bezel liquid crystal display device, comprising a rear enclosure, a front enclosure mating the rear enclosure, and a liquid crystal display module arranged inside the rear enclosure, the liquid crystal display module having opposite sides each forming a first retention section, the rear enclosure forming second retention sections corresponding to the first retention sections, the first retention sections and the second retention sections being engageable with and coupled to each other so as to fix the liquid crystal display module inside the rear enclosure.

2. The slim bezel liquid crystal display device as claimed in claim 1, wherein the liquid crystal display module comprises a back frame and a liquid crystal display panel received in the back frame, the first retention sections being respectively formed on opposite sides of the back frame.

3. The slim bezel liquid crystal display device as claimed in claim 2, wherein the rear enclosure comprises a bottom board, first and second side boards respectively connected to opposite sides of the bottom board, and a third side board connected to the bottom board and also connected to the first and second side boards, the bottom board and the first, second, and third side boards delimiting an accommodation space that has an opening, the liquid crystal display module being received in the accommodation space.

4. The slim bezel liquid crystal display device as claimed in claim 3, wherein the second retention sections are formed in inside surfaces of the first and second side boards to respectively correspond to the first retention sections.

5. The slim bezel liquid crystal display device as claimed in claim 3, wherein the front enclosure comprises a frame body and a stop plate extending from one side of the frame body, the stop plate being provided to correspond to the opening of the rear enclosure, whereby after assembling, the stop plate completely covers and shields the opening.

6. The slim bezel liquid crystal display device as claimed in claim 4, wherein the first retention sections are raised portions, the first retention sections projecting outwardly from the opposite sides of the back frame, the second retention sections being slots, the second retention sections being formed by recessing inside surfaces of the first and second side boards.

7. The slim bezel liquid crystal display device as claimed in claim 6, wherein the first retention sections have a rectangular cross-section, the second retention sections being rectangular slots corresponding to the first retention sections.

8. The slim bezel liquid crystal display device as claimed in claim 6, wherein the first retention sections have a trapezoidal cross-section, the first retention sections getting expanded in extending outward from the end thereof adjacent to the back frame, the second retention sections being trapezoidal slots corresponding to the first retention sections.

9. The slim bezel liquid crystal display device as claimed in claim 4, wherein the first retention sections are slots, the first retention sections being formed by inwardly recessing opposite sides of the back frame, the second retention sections being raised portions, the second retention sections being formed by projecting inwardly from inside surfaces of the first and second side boards.

10. The slim bezel liquid crystal display device as claimed in claim 9, wherein the first retention sections are rectangular or trapezoidal slots and the second retention sections have a cross-section that is trapezoidal or rectangular in shape to correspond to the first retention sections.

11. A slim bezel liquid crystal display device, comprising a rear enclosure, a front enclosure mating the rear enclosure, and a liquid crystal display module arranged inside the rear enclosure, the liquid crystal display module having opposite sides each forming a first retention section, the rear enclosure forming second retention sections corresponding to the first retention sections, the first retention sections and the second retention sections being engageable with and coupled to each other so as to fix the liquid crystal display module inside the rear enclosure;
wherein the liquid crystal display module comprises a back frame and a liquid crystal display panel received in the back frame, the first retention sections being respectively formed on opposite sides of the back frame;
wherein the rear enclosure comprises a bottom board, first and second side boards respectively connected to opposite sides of the bottom board, and a third side board connected to the bottom board and also connected to the first and second side boards, the bottom board and the first, second, and third side boards delimiting an accommodation space that has an opening, the liquid crystal display module being received in the accommodation space;
wherein the second retention sections are formed in inside surfaces of the first and second side boards to respectively correspond to the first retention sections;
wherein the front enclosure comprises a frame body and a stop plate extending from one side of the frame body, the stop plate being provided to correspond to the opening of the rear enclosure, whereby after assembling, the stop plate completely covers and shields the opening;
wherein the first retention sections are raised portions, the first retention sections projecting outwardly from the opposite sides of the back frame, the second retention sections being slots, the second retention sections being formed by recessing inside surfaces of the first and second side boards; and
wherein the first retention sections have a rectangular cross-section, the second retention sections being rectangular slots corresponding to the first retention sections.
